(19) United States
(12) Patent Application Publication
(10) Pub. No.: US 2019/0100254 A1
(43) Pub. Date: Apr. 4, 2019

(54) Tapered fuel efficient cargo bulk liquid and dry van trailer and recreational vehicle that is wider in front and smaller in rear

(71) Applicant: Erick Heiens, Fall river, KS (US)

(72) Inventor: Erick Heiens, Fall river, KS (US)

(21) Appl. No.: 15/722,103

(22) Filed: Oct. 2, 2017

(51) Int. Cl. B62D 33/04

(52) U.S. Cl. CPC B62D 33/04

(57) ABSTRACT

A tapered fuel efficient cargo bulk liquid and dry van trailer that is wider in front and smaller in rear is disclosed. A tapered trailer which is wider and or taller at the front of the trailer and shorter and or narrower at the rear of trailer is a large improvement in air drag and aerodynamics and increases fuel economy when in operation while maintaining volume capacity of a conventional trailer.

### BACKGROUND OF THE INVENTION

### Problem Solved: Excess Fuel Consumption

The conventional rectangular trailers burn too much fuel

A tapered trailer which is wider and or taller at the front of the of the trailer and shorter and or narrower at the rear of trailer is a large improvement in air drag and aerodynamics and increases fuel economy when in operation while maintaining volume capacity of a conventional trailer

### DETAILED DESCRIPTION OF THE INVENTION

As stated above, excess fuel consumption. The invention claimed here solves this problem.

A tapered cargo trailer that is wider and/or taller at the front of trailer and smaller at the rear of trailer reduces wind drag making the trailer more fuel efficient and cost effective

The claimed invention differs from what currently exists. A tapered trailer is superior to conventional rectangular trailers because the “tapered” wider and or taller at the front and narrower at the rear is more fuel efficient while maintaining volume

This invention is an improvement on what currently exists. A tapered trailer is superior to conventional rectangular trailers because the “tapered” wider and or taller at the front and narrower at the rear is more fuel efficient while maintaining volume

The right angle conventional trailers are not the most aerodynamic design

A tapered trailer which is wider and or taller at the front of the of the trailer and shorter and or narrower at the rear of trailer is a large improvement in air drag and aerodynamics and increases fuel economy when in operation while maintaining volume capacity of a conventional trailer

Also, it can produce this invention produces better fuel economy

### THE VERSION OF THE INVENTION DISCUSSED HERE INCLUDES

1. the front of trailer would be x″ wide and x″ tall and the rear of trailer would be x″-y″ wide and x″-y″ to

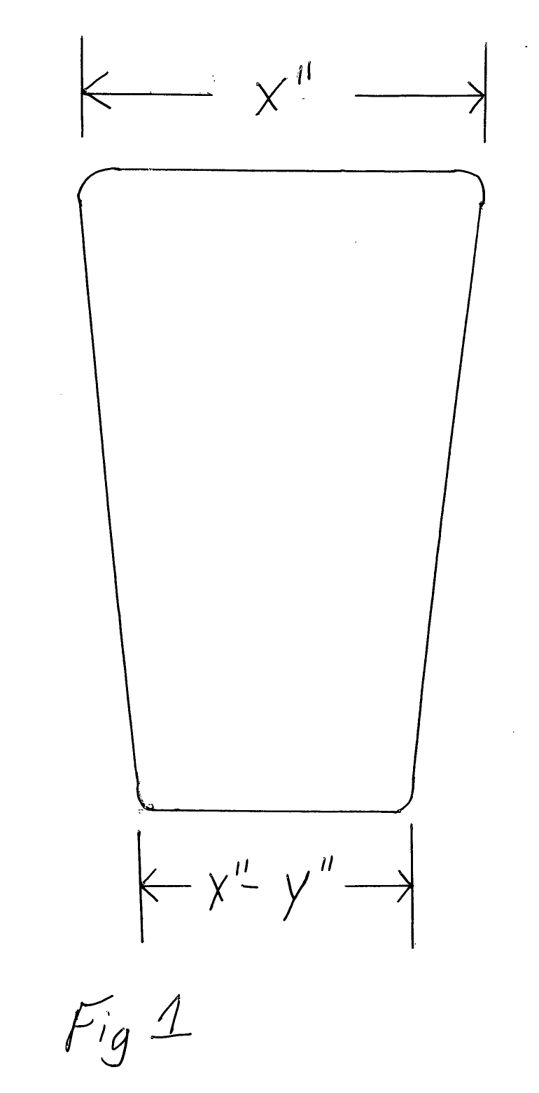

FIG. 1 describes an overhead view of a bulk liquid cargo trailer. The trailer is wider in the front and narrower in the rear.

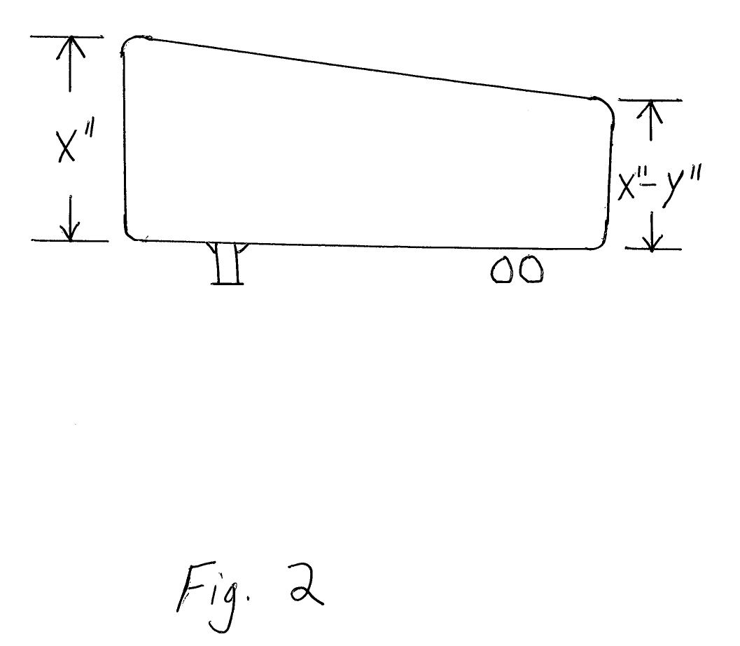

FIG. 2 shows a side view of a bulk liquid cargo trailer that is taller in the front and narrower in the rear of the trailer.

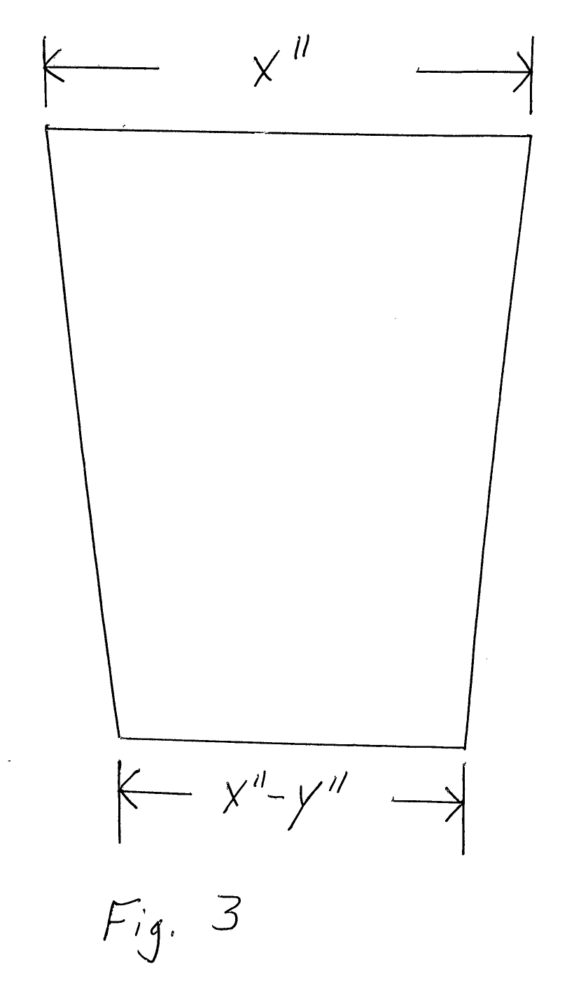

FIG. 3 describes an overhead view of a dry van and/or refrigerated trailer that is wider in the front and narrower in the rear of the trailer.

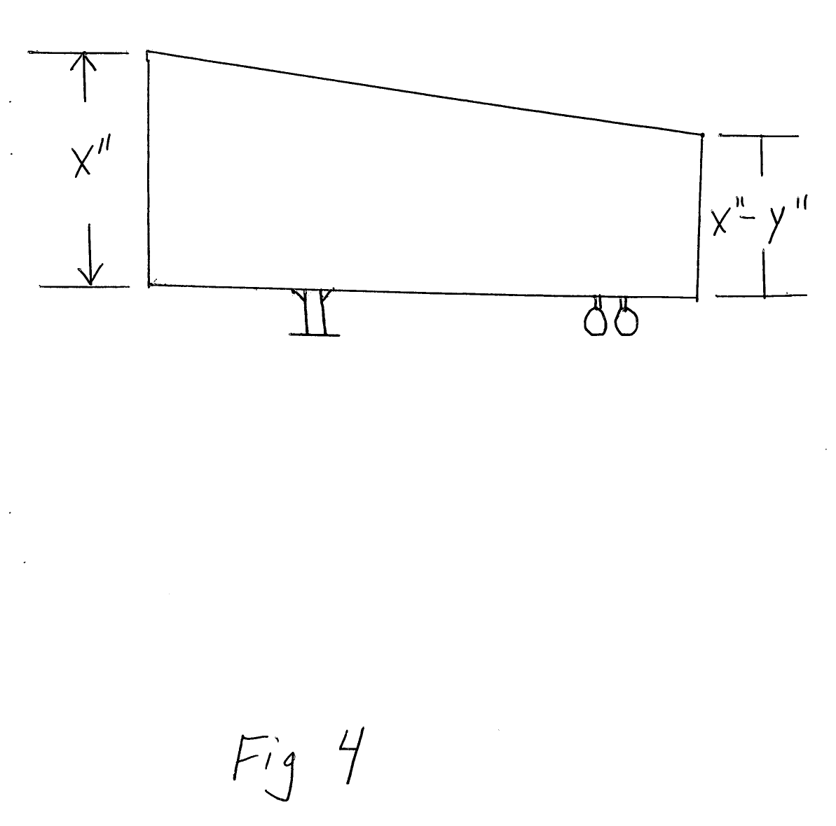

FIG. 4 shows a side view of a dry van and/or refrigerated trailer that is taller in front and narrower in the rear of the trailer.

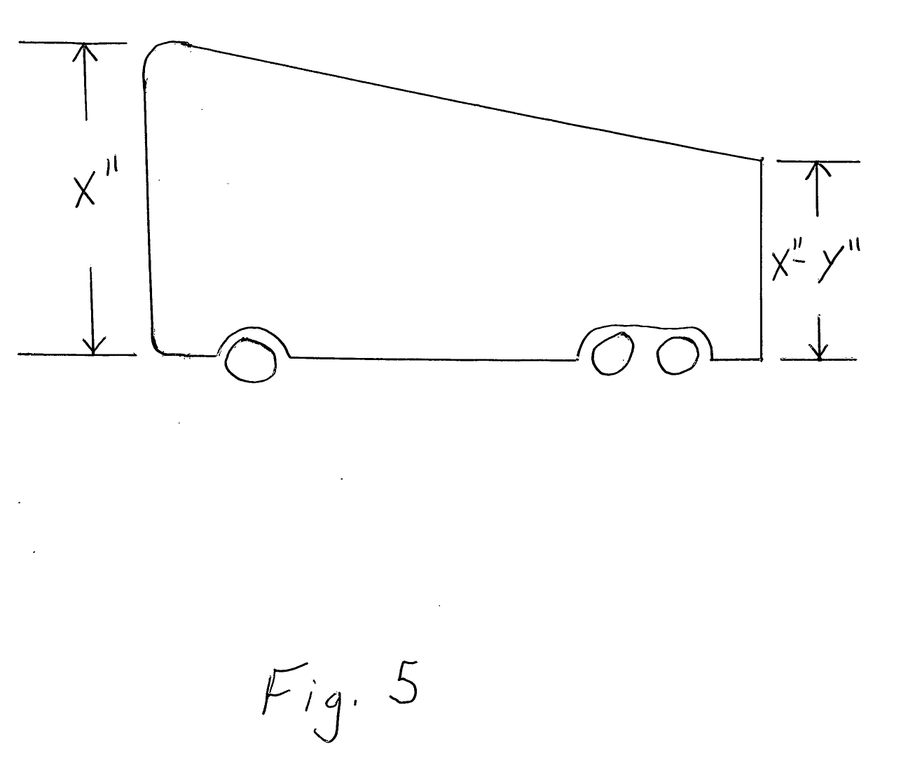

FIG. 5 describes a side view of a recreational vehicle that is taller in the front and narrower in the end.

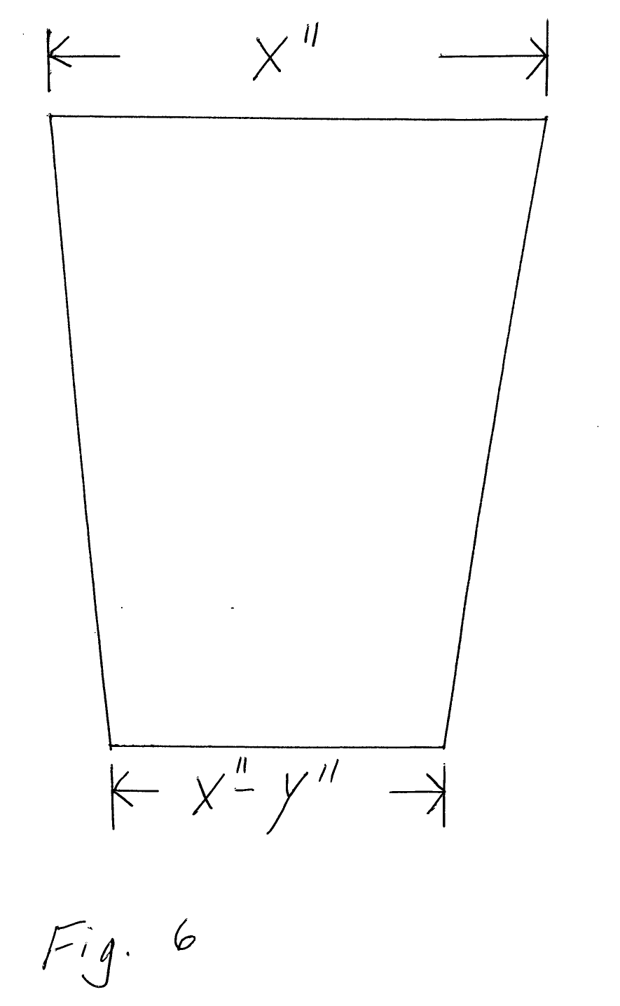

FIG. 6 shows an overhead view of a recreational vehicle that is wider in the front and smaller in the end.

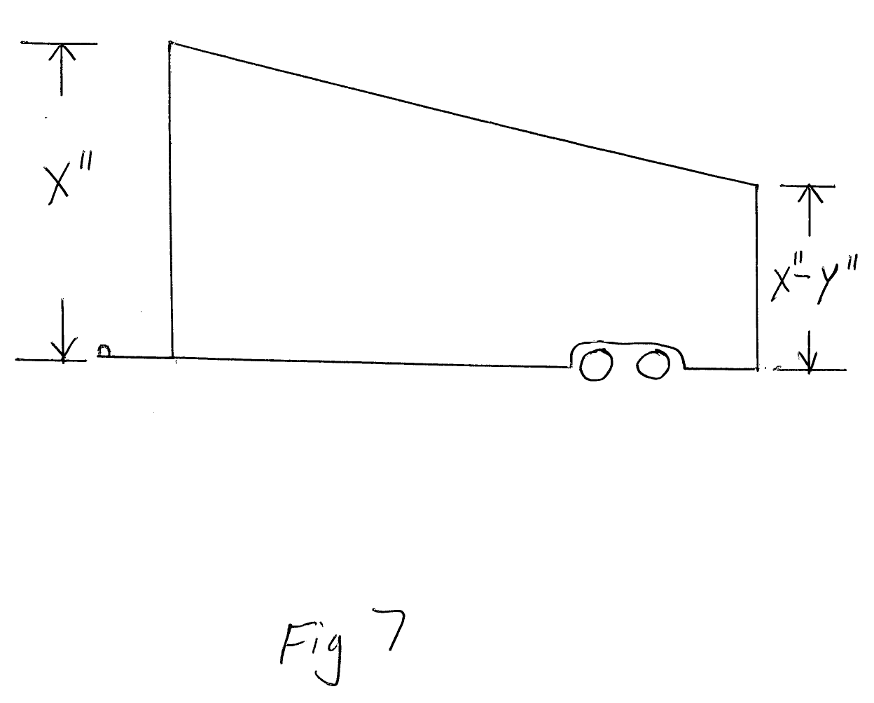

FIG. 7 describes a side view of a recreational trailer that is taller in the front and shorter in the rear.

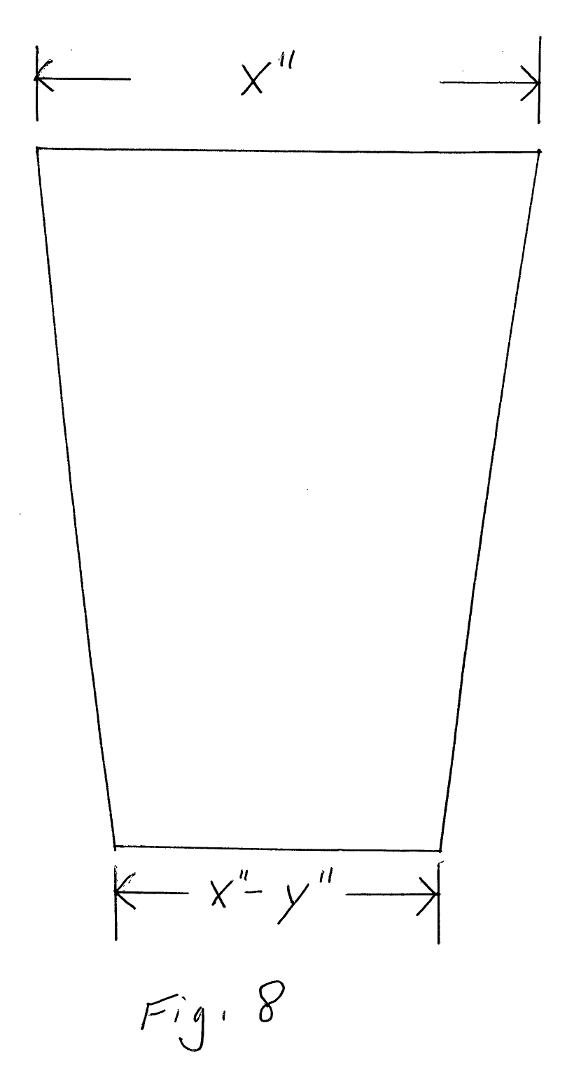

FIG. 8 shows an overhead view of a recreational trailer that is wider in the front and narrower in the rear of the trailer.

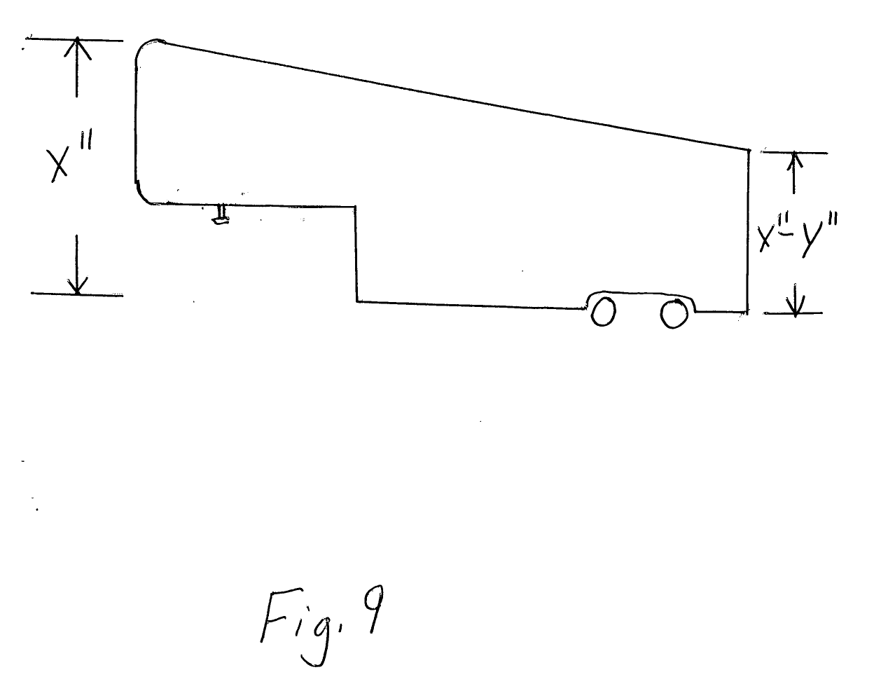

FIG. 9 describes a side view a fifth wheel recreational vehicle that is taller in the front and tapers to shorter in the rear of the trailer.

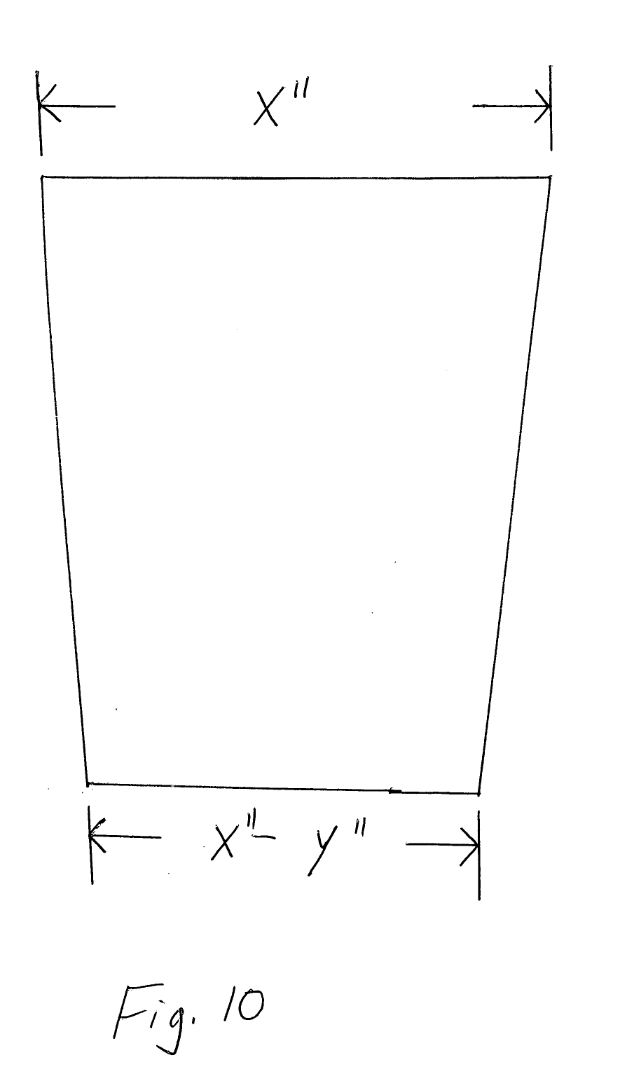

FIG. 10 shows an overhead view of a fifth wheel trailer that is wider in front end and tapers to a smaller end in the rear of the trailer.

1- The tapered trailer is more fuel efficient than conventional trailers that are in operation today.

2- The tapered shape is better aerodynamically which creates better fuel mileage.

3- The tapered shape creates less wind drag.

4- Because there is less wind drag and it is more aerodynamic the invention is easier to drive or pull.

5- Because the invention is more fuel efficient, it will reduce pollution and CO-2 emissions making for a better environment and a better world.
